(19) United States
(12) Patent Application Publication
(10) Pub. No.: US 2023/0368576 A1
(43) Pub. Date: Nov. 16, 2023

(54) IMAGE PROCESSING APPARATUS, IMAGE PROCESSING METHOD, AND NON-TRANSITORY STORAGE MEDIUM

(71) Applicant: NEC Corporation, Minato-ku, Tokyo (JP)

(72) Inventors: Karen STEPHEN, Tokyo (JP); Jianquan LIU, Tokyo (JP)

(73) Assignee: NEC Corporation, Minato-ku, Tokyo (JP)

(21) Appl. No.: 18/026,407

(22) PCT Filed: Sep. 25, 2020
(86) PCT No.: PCT/JP2020/036225

§ 371 Date: Mar. 15, 2023

(51) Int. Cl. G06V 40/20; G06T 3/60; G06T 7/66

(52) U.S. Cl. CPC G06V 40/20; G06T 3/60; G06T 7/66; G06V 2201/07; G06T 2207/20132

(57) ABSTRACT

The present invention provides an image processing apparatus (10) including: a first estimation unit (11) performing image analysis on a panoramic image acquired by panoramically expanding a fisheye image generated by a fisheye lens camera and estimating a human action indicated by the panoramic image; a second estimation unit (12) performing image analysis on a partial fisheye image being a partial area in the fisheye image without panoramic expansion and estimating a human action indicated by the partial fisheye image; and a third estimation unit (13) estimating a human action indicated by the fisheye image, based on an estimation result based on the panoramic image and an estimation result based on the partial fisheye image.

### TECHNICAL FIELD

The present invention relates to an image processing apparatus, an image processing method, and a program.

### BACKGROUND ART

Patent Document 1 discloses a technology for performing machine learning, based on a training image and information for identifying a location of a business store. Then, Patent Document 1 discloses that a panoramic image, an image the field of view of which is greater than 180°, and the like can be set as a training image.

Non-Patent Document 1 discloses a technology for estimating a human action indicated by a dynamic image, based on a 3D-convolutional neural network (CNN).

### RELATED DOCUMENT

### Patent Document

Patent Document 1: Japanese Translation of PCT International Application Publication No. 2018-524678

### Non Patent Document

Non-Patent Document 1: Kensho Hara, et al., “Can Spatiotemporal 3D CNNs Retrace the History of 2D CNNs and ImageNet?” [online], Proceedings of the IEEE conference on Computer Vision and Pattern Recognition (pp. 6546 to 6555), [retrieved on May 28, 2019], the Internet <URL: http://openaccess.thecvf.com/content_cvpr_2018/papers/HaraCan_Spatiotemporal_3D_CVPR_2018paper.pdf>

### DISCLOSURE OF THE INVENTION

### Technical Issue

An image can be captured over a wide area by using a fisheye lens. By taking advantage of such a characteristic, a fisheye lens is widely used in a surveillance camera and the like. Then, the present inventors have examined a technology for estimating a human action, based on an image generated by using a fisheye lens (may be hereinafter referred to as a “fisheye image”).

Since distortion occurs in a fisheye image, a direction of gravity may vary for each position in the image. Therefore, an unnatural situation such as a direction in which the body of a standing person extends varying for each position in the image may occur. A sufficient estimation result cannot be acquired when such a fisheye image is input to a human action estimation model generated by machine learning based on an image (learning data) generated by using a standard lens (for example, with an angle of view around 40° to around 60°).

A means for generating a panoramic image by panoramically expanding a fisheye image and inputting the panoramic image to the aforementioned human action estimation model is considered as a means for solving the issue. An outline of panoramic expansion will be described by using FIG. 1.

First, a reference line Lₛ a reference point (x_{c}, y_{c}), a width w, and a height h are determined. The reference line Lₛ is a line connecting the reference point (x_{c}, y_{c}) and any point on the outer periphery of a circular image and is a position where a fisheye image is cut open at panoramic expansion. An image around the reference line Lₛ is the position of an edge in the panoramic image. There are various methods for determining the reference line Lₛ. The reference point (x_{c}, y_{c}) is a point in a circular intra-image-circle image in the fisheye image and, for example, is the center of the circle. The width w is the width of the panoramic image, and the height h is the height of the panoramic image. The values may be default values or may be freely set by a user.

When the values are determined, any target point (x_{f}, y_{f}) in the fisheye image can be transformed into a point (xₚ, yₚ) in the panoramic image in accordance with an illustrated equation of “panoramic expansion.” When any target point (x_{f}, y_{f}) in the fisheye image is specified, a distance r_{f} between the reference point (x_{c}, y_{c}) and the target point (x_{f}, y_{f}) can be computed. Similarly, an angle θ formed between a line connecting the reference point (x_{c}, y_{c}) and the target point (x_{f}, y_{f}), and the reference line Lₛ can be computed. As a result, values of the variables w, θ, h, r_{f}, and r in the illustrated equation of “panoramic expansion” are determined. Note that r is the radius of the intra-image-circle image. By substituting the values of the variables into the equation, the point (xₚ, yₚ) can be computed.

Further, a panoramic image can be transformed into a fisheye image in accordance with an illustrated equation of “inverse panoramic expansion.”

Unnaturalness such as a direction in which the body of a standing person extends varying for each position in an image can indeed be reduced by generating a panoramic image by panoramically expanding a fisheye image. However, in the case of the aforementioned panoramic expansion technique, an image around the reference point (x_{c}, y_{c}) is considerably enlarged when the panoramic image is generated from the fisheye image, and therefore a person around the reference point (x_{c}, y_{c}) may be considerably distorted in the panoramic image. Therefore, issues such as the distorted person being undetectable and estimation precision being degraded may occur in estimation of a human action based on a panoramic image.

An object of the present invention is to provide high-precision estimation of an action of a person included in a fisheye image.

### Solution to Problem

The present invention provides an image processing apparatus including:

a first estimation unit that performs image analysis on a panoramic image acquired by panoramically expanding a fisheye image generated by a fisheye lens camera and estimating a human action indicated by the panoramic image;

a second estimation unit that performs image analysis on a partial fisheye image being a partial area in the fisheye image without panoramic expansion and estimating a human action indicated by the partial fisheye image; and

a third estimation unit that estimates a human action indicated by the fisheye image, based on an estimation result based on the panoramic image and an estimation result based on the partial fisheye image.

Further, the present invention provides an image processing method including, by a computer:

performing image analysis on a panoramic image acquired by panoramically expanding a fisheye image generated by a fisheye lens camera and estimating a human action indicated by the panoramic image;

performing image analysis on a partial fisheye image being a partial area in the fisheye image without panoramic expansion and estimating a human action indicated by the partial fisheye image; and

estimating a human action indicated by the fisheye image, based on an estimation result based on the panoramic image and an estimation result based on the partial fisheye image.

Further, the present invention provides a program causing a computer to function as:

a first estimation unit that performs image analysis on a panoramic image acquired by panoramically expanding a fisheye image generated by a fisheye lens camera and estimating a human action indicated by the panoramic image;

a second estimation unit that performs image analysis on a partial fisheye image being a partial area in the fisheye image without panoramic expansion and estimating a human action indicated by the partial fisheye image; and

a third estimation unit that estimates a human action indicated by the fisheye image, based on an estimation result based on the panoramic image and an estimation result based on the partial fisheye image.

### Advantageous Effects of Invention

The present invention enables high-precision estimation of an action of a person included in a fisheye image.

### BRIEF DESCRIPTION OF THE DRAWINGS

The aforementioned object, and other objects, features, and advantages will become more apparent by the following preferred example embodiments and accompanying drawings.

FIG. 1 is a diagram illustrating a technique for panoramic expansion.

FIG. 2 is a diagram for illustrating an outline of an image processing apparatus according to the present example embodiment.

FIG. 3 is a diagram illustrating an example of a hardware configuration of the image processing apparatus and a processing apparatus, according to the present example embodiment.

FIG. 4 is an example of a functional block diagram of the image processing apparatus according to the present example embodiment.

FIG. 5 is a diagram for illustrating processing in the image processing apparatus according to the present example embodiment.

FIG. 6 is a diagram for illustrating the processing in the image processing apparatus according to the present example embodiment.

FIG. 7 is a diagram for illustrating the processing in the image processing apparatus according to the present example embodiment.

FIG. 8 is a diagram for illustrating the processing in the image processing apparatus according to the present example embodiment.

FIG. 9 is a diagram for illustrating the processing in the image processing apparatus according to the present example embodiment.

FIG. 10 is a diagram for illustrating the processing in the image processing apparatus according to the present example embodiment.

FIG. 11 is a diagram for illustrating the processing in the image processing apparatus according to the present example embodiment.

FIG. 12 is a flowchart illustrating an example of a flow of processing in the image processing apparatus according to the present example embodiment.

FIG. 13 is a flowchart illustrating an example of a flow of processing in the image processing apparatus according to the present example embodiment.

FIG. 14 is a flowchart illustrating an example of a flow of processing in the image processing apparatus according to the present example embodiment.

FIG. 15 is a flowchart illustrating an example of a flow of processing in the image processing apparatus according to the present example embodiment.

FIG. 16 is a diagram for illustrating processing in the image processing apparatus according to the present example embodiment.

FIG. 17 is a diagram for illustrating processing in the image processing apparatus according to the present example embodiment.

FIG. 18 is a diagram for illustrating processing in the image processing apparatus according to the present example embodiment.

FIG. 19 is an example of a block diagram of the image processing apparatus according to the present example embodiment.

FIG. 20 is a flowchart illustrating an example of a flow of processing in the image processing apparatus according to the present example embodiment.

FIG. 21 is a diagram for illustrating processing in the image processing apparatus according to the present example embodiment.

FIG. 22 is a diagram for illustrating processing in the image processing apparatus according to the present example embodiment.

FIG. 23 is a diagram for illustrating processing in the image processing apparatus according to the present example embodiment.

### DESCRIPTION OF EMBODIMENTS

### Outline

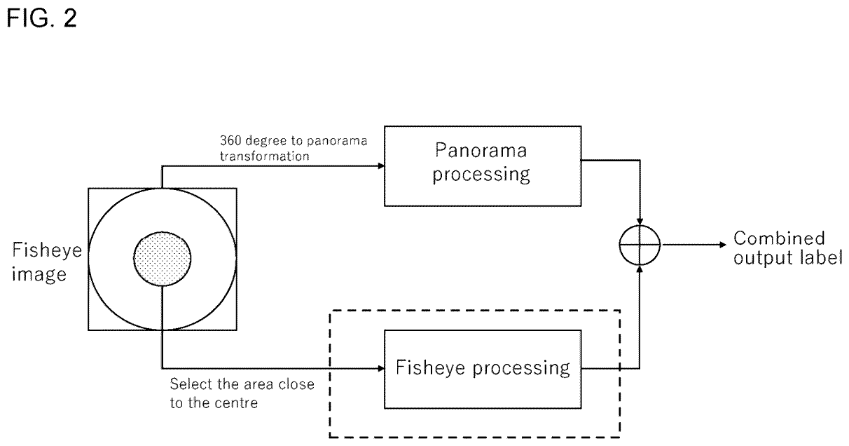

First, an outline of the image processing apparatus 10 according to the present example embodiment will be described by using FIG. 2.

As illustrated, the image processing apparatus 10 executes panorama processing, fisheye processing, and aggregation processing.

In the panorama processing, the image processing apparatus 10 performs image analysis on a panoramic image acquired by panoramically expanding a fisheye image and estimates a human action indicated by the panoramic image. In the fisheye processing, the image processing apparatus 10 performs image analysis on a partial fisheye image being a partial area of the fisheye image without panoramic expansion and estimates a human action indicated by the partial fisheye image. Then, in the aggregation processing, the image processing apparatus 10 estimates a human action indicated by the fisheye image, based on the estimation result of a human action based on the panoramic image acquired in the panorama processing and the estimation result of a human action based on the partial fisheye image acquired in the fisheye processing.

### Hardware Configuration

Next, an example of a hardware configuration of the image processing apparatus 10 will be described. Each functional unit included in the image processing apparatus 10 is provided by any combination of hardware and software centered on a central processing unit (CPU), a memory, a program loaded into the memory, a storage unit storing the program [capable of storing not only a program previously stored in the shipping stage of the apparatus but also a program downloaded from a storage medium such as a compact disc (CD) or a server on the Internet], such as a hard disk, and a network connection interface in any computer. Then, it may be understood by a person skilled in the art that various modifications to the providing method and the apparatus can be made.

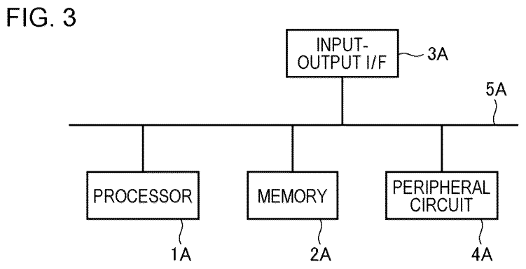

FIG. 3 is a block diagram illustrating a hardware configuration of the image processing apparatus 10. As illustrated in FIG. 3, the image processing apparatus 10 includes a processor 1A, a memory 2A, an input-output interface 3A, a peripheral circuit 4A, and a bus 5A. Various modules are included in the peripheral circuit 4A. The image processing apparatus 10 may not include the peripheral circuit 4A. Note that the image processing apparatus 10 may be configured with a plurality of physically and/or logically separate apparatuses or may be configured with one physically and/or logically integrated apparatus. When the image processing apparatus 10 is configured with a plurality of physically and/or logically separate apparatuses, each of the plurality of apparatuses may include the aforementioned hardware configuration.

The bus 5A is a data transmission channel for the processor 1A, the memory 2A, the peripheral circuit 4A, and the input-output interface 3A to transmit and receive data to and from one another. Examples of the processor 1A include arithmetic processing units such as a CPU and a graphics processing unit (GPU). Examples of the memory 2A include memories such as a random-access memory (RAM) and a read-only memory (ROM). The input-output interface 3A includes an interface for acquiring information from an input apparatus, an external apparatus, an external server, an external sensor, a camera, and the like, and an interface for outputting information to an output apparatus, the external apparatus, the external server, and the like. Examples of the input apparatus include a keyboard, a mouse, a microphone, a physical button, and a touch panel. Examples of the output apparatus include a display, a speaker, a printer, and a mailer. The processor 1A issues an instruction to each module and can perform an operation, based on the operation result by the module.

### Functional Configuration

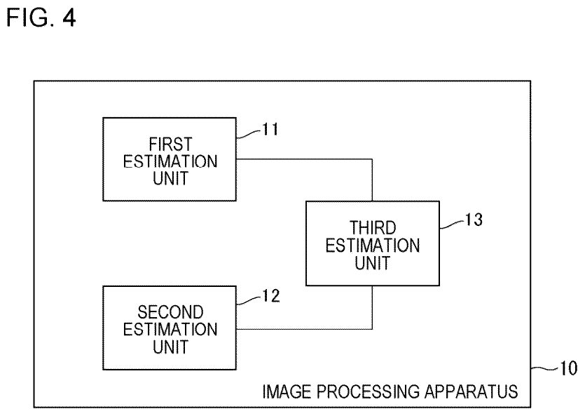

Next, a functional configuration of the image processing apparatus 10 will be described. FIG. 4 illustrates an example of a functional block diagram of the image processing apparatus 10. As illustrated, the image processing apparatus 10 includes a first estimation unit 11, a second estimation unit 12, and a third estimation unit 13. The functional units execute the panorama processing, the fisheye processing, and the aggregation processing that are described above. Configurations of the functional units will be described below for each type of processing.

### Panorama Processing

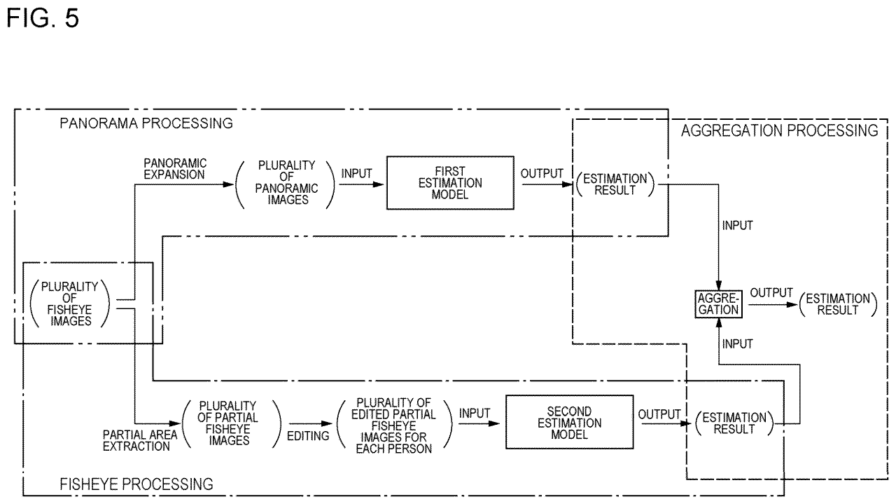

The panorama processing is executed by the first estimation unit 11. A flow of the panorama processing is described in more detail in FIG. 5. As illustrated, when acquiring a plurality of time-series fisheye images (fisheye image acquisition processing), the first estimation unit 11 generates a plurality of time-series panoramic images by panoramically expanding each fisheye image (panoramic expansion processing). Subsequently, based on the plurality of time-series panoramic images and a first estimation model, the first estimation unit 11 estimates a human action indicated by the plurality of time-series panoramic images (first estimation processing). Thus, the panorama processing includes the fisheye image acquisition processing, the panoramic expansion processing, and the first estimation processing. Each type of processing is described in detail below.

### Fisheye Image Acquisition Processing

In the fisheye image acquisition processing, the first estimation unit 11 acquires a plurality of time-series fisheye images. A fisheye image is an image generated by using a fisheye lens. For example, the plurality of time-series fisheye images may constitute a dynamic image or be a plurality of consecutive static images generated by consecutively capturing images at predetermined time intervals.

Note that “acquisition” herein may include “an apparatus getting data stored in another apparatus or a storage medium (active acquisition)” in accordance with a user input or a program instruction, such as making a request or an inquiry to another apparatus and receiving a response, and readout by accessing another apparatus or a storage medium. Further, “acquisition” may include “an apparatus inputting data output from another apparatus to the apparatus (passive acquisition)” in accordance with a user input or a program instruction, such as reception of distributed (or, for example, transmitted or push notified) data. Further, “acquisition” may include acquisition by selection from received data or information and “generating new data by data editing (such as conversion to text, data rearrangement, partial data extraction, or file format change) and acquiring the new data”.

### Panoramic Expansion Processing

In the panoramic expansion processing, the first estimation unit 11 generates a plurality of time-series panoramic images by panoramically expanding each of a plurality of time-series fisheye images. While an example of a technique for panoramic expansion will be described below, another technique may be employed.

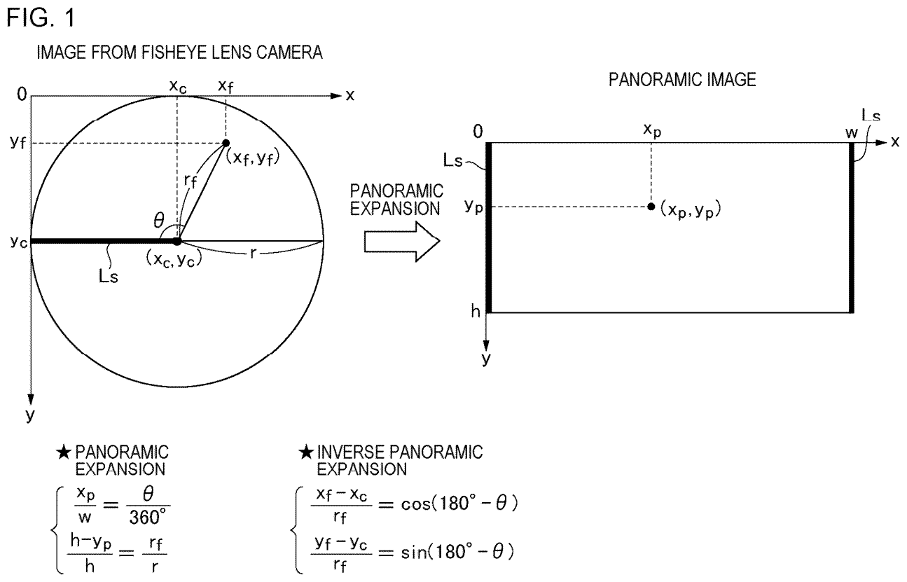

First, the first estimation unit 11 determines a reference line Lₛ, a reference point (x_{c}, y_{c}), a width w, and a height h (see FIG. 1).

Determination of Reference Point (x_{c}, y_{c})

First, the first estimation unit 11 detects a plurality of predetermined points of the body of each of a plurality of persons from a circular intra-image-circle image in a fisheye image. Then, based on the plurality of detected predetermined points, the first estimation unit 11 determines a direction of gravity (vertical direction) at the position of each of the plurality of persons.

For example, the first estimation unit 11 may detect a plurality of points (two points) of the body, a line connecting the points being parallel to the direction of gravity, in an image generated by capturing an image of a standing person from the front. Examples of such a combination of two points include (the midpoint between both shoulders, the midpoint between hips), (the top of the head, the midpoint between hips), and (the top of the head, the midpoint between both shoulders) but are not limited thereto. In this example, the first estimation unit 11 determines a direction from one predetermined point out of two points detected in relation to each person toward the other point as a direction of gravity.

As another example, the first estimation unit 11 may detect a plurality of points (two points) of the body, a line connecting the points being perpendicular to the direction of gravity, in an image generated by capturing an image of a standing person from the front. Examples of such a combination of two points include (right shoulder, left shoulder) and (right hip, left hip) but are not limited thereto. In this example, the first estimation unit 11 determines a direction in which a line passing through the midpoint of two points detected in relation to each person and being perpendicular to a line connecting the two points extends as a direction of gravity.

Note that the first estimation unit 11 may detect the aforementioned plurality of points of the body by using every image analysis technology. For example, the first estimation unit 11 can detect a plurality of predetermined points of the body of each of a plurality of persons by analyzing a fisheye image by the same algorithm as “an algorithm for detecting a plurality of predetermined points of the body of each person existing in an image generated by using a standard lens (for example, with an angle of view around 40° to around 60°).”

However, directions in which the bodies of standing persons extend may vary in a fisheye image. Then, the first estimation unit 1 may perform image analysis while rotating the fisheye image. Specifically, the first estimation unit 11 may perform processing of rotating an intra-image-circle image in the fisheye image and detecting a plurality of predetermined points of the body of a person by analyzing the intra-image-circle image after rotation.

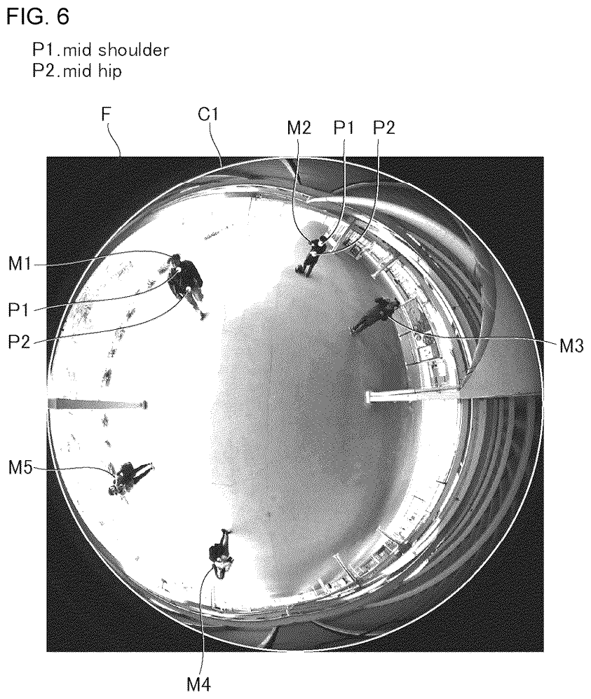

An outline of the processing will be described by using FIG. 6 to FIG. 9. In an example in FIG. 6, five persons M1 to M5 exist in an intra-image-circle image C1 in a fisheye image F. While all persons M1 to M5 are standing, directions in which the bodies extend vary.

The first estimation unit 11 first analyzes the image in a rotation state illustrated in FIG. 6 and performs processing of detecting the midpoint P1 between both shoulders and the midpoint P2 between hips for each person. In this case, the first estimation unit 11 can detect the points P1 and P2 for the persons M1 and M2, the extending direction of the body of each person being close to the vertical direction in the diagram, but cannot detect the points P1 and P2 for other persons.

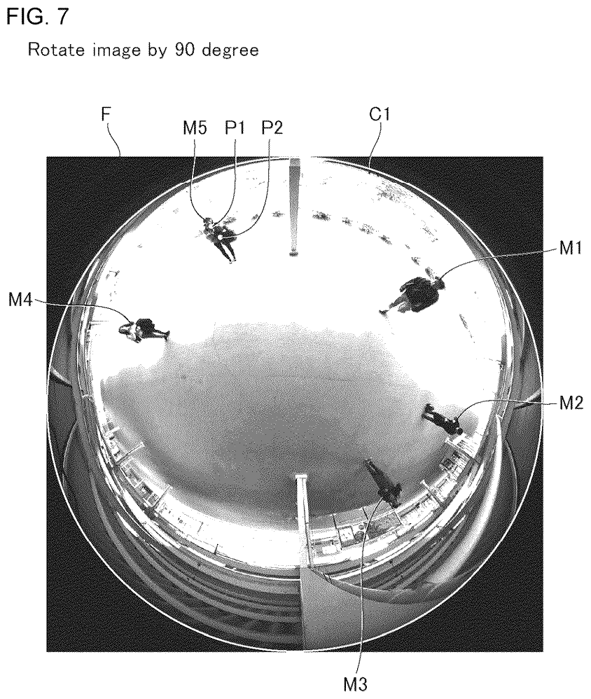

Next, the first estimation unit 11 rotates the fisheye image F by 90°. Then, the rotation state becomes a state in FIG. 7. The first estimation unit 11 analyzes the image in the rotation state and performs the processing of detecting the midpoint P1 between both shoulders and the midpoint P2 between hips for each person. In this case, the first estimation unit 11 can detect the points P1 and P2 for the person M5 the extending direction of the body of whom is close to the vertical direction in the diagram but cannot detect the points P1 and P2 for the other persons.

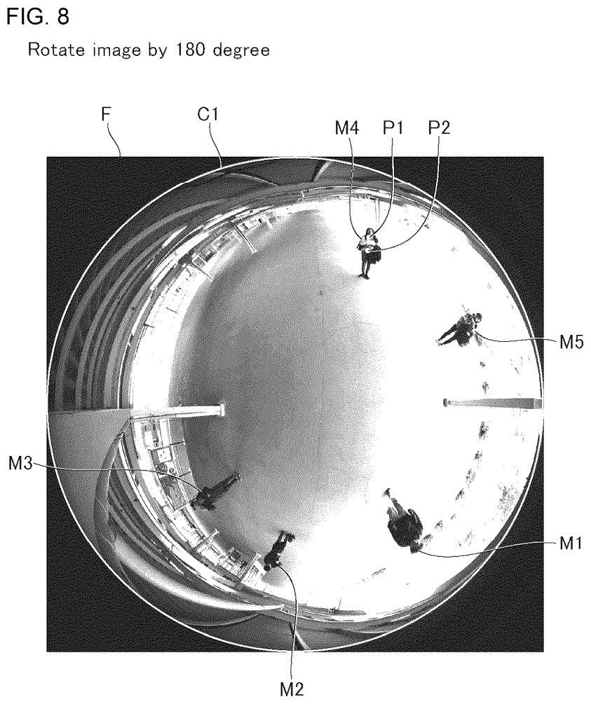

Next, the first estimation unit 11 further rotates the fisheye image F by 90°. Then, the rotation state becomes a state in FIG. 8. The first estimation unit 11 analyzes the image in the rotation state and performs the processing of detecting the midpoint P1 between both shoulders and the midpoint P2 between hips for each person. In this case, the first estimation unit 11 can detect the points P1 and P2 for the person M4 the extending direction of the body of whom is close to the vertical direction in the diagram but cannot detect the points P1 and P2 for the other persons.

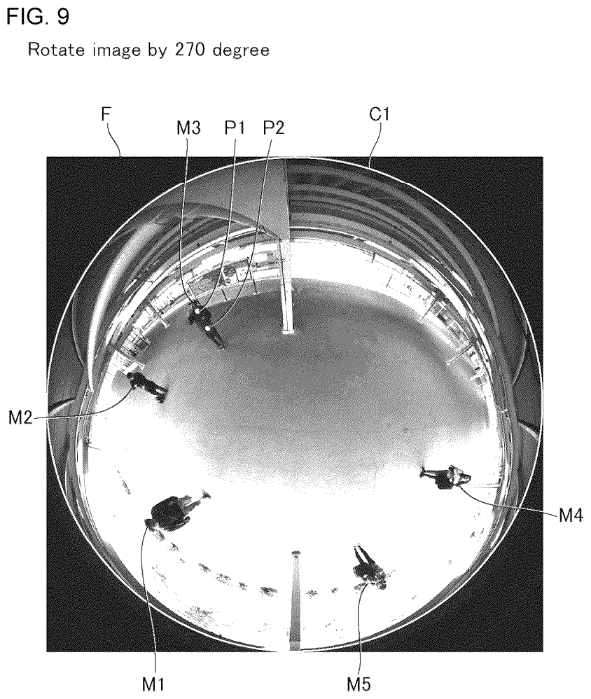

Next, the first estimation unit 11 further rotates the fisheye image F by 90°. Then, the rotation state becomes a state in FIG. 9. The first estimation unit 11 analyzes the image in the rotation state and performs the processing of detecting the midpoint P1 between both shoulders and the midpoint P2 between hips for each person. In this case, the first estimation unit 11 can detect the points P1 and P2 for the person M3 the extending direction of the body of whom is close to the vertical direction in the diagram but cannot detect the points P1 and P2 for the other persons.

Thus, by analyzing a fisheye image while rotating the image, the first estimation unit 11 can detect a plurality of predetermined points of the body of each of a plurality of persons the bodies of whom extend in varying directions. Note that while rotation is performed in steps of 90° in the aforementioned example, the above is strictly an example, and the steps are not limited thereto.

Next, the first estimation unit 11 determines a reference point (x_{c}, y_{c}), based on the direction of gravity at the position of each of the plurality of persons in the fisheye image. Then, the first estimation unit 11 causes a storage unit in the image processing apparatus 10 to store the determined reference point (x_{c}, y_{c}).

When straight lines each passing through the position of each of the plurality of persons and extending in the direction of gravity at the position of the person intersect at one point, the first estimation unit 11 determines the point of intersection to be the reference point (x_{c}, y_{c}).

On the other hand, when straight lines each passing through the position of each of the plurality of persons and extending in the direction of gravity at the position of the person do not intersect at one point, the first estimation unit 11 determines a point the distance to which from each of the plurality of straight lines satisfies a predetermined condition to be the reference point (x_{c}, y_{c}).

When the first estimation unit 11 detects a plurality of points (two points) of the body, a line connecting the points being parallel to the direction of gravity in an image generated by capturing an image of a standing person from the front, “a straight line passing through the position of each of the plurality of persons and extending in the direction of gravity at the position of the person” may be a line connecting the two points detected by the first estimation unit 11.

Then, when the first estimation unit 11 detects a plurality of points (two points) of the body, a line connecting the points being perpendicular to the direction of gravity in an image generated by capturing an image of a standing person from the front, “a straight line passing through the position of each of the plurality of persons and extending in the direction of gravity at the position of the person” may be a line passing through the midpoint between the two points detected by the first estimation unit 11 and being perpendicular to a line connecting the two points.

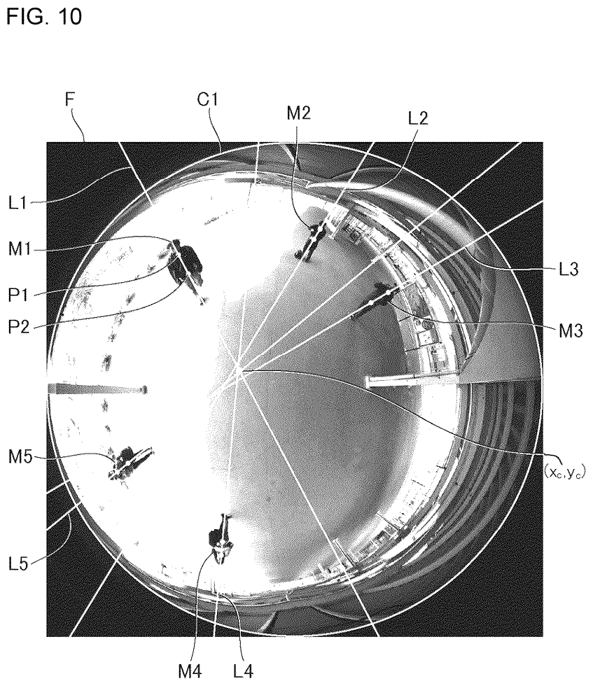

FIG. 10 illustrates a concept of reference point determination processing by the first estimation unit 11. In an illustrated example, the first estimation unit 11 detects the midpoint P1 between both shoulders and the midpoint P2 between hips of each person. Then, lines connecting the points P1 and P2 are “straight lines L1 to L5 each passing through the position of each of a plurality of persons and extending in the direction of gravity at the position of the person.” In the illustrated example, the plurality of straight lines L1 to L5 do not intersect at one point. Therefore, the first estimation unit 11 determines a point the distance from which to each of the plurality of straight lines L1 to L5 satisfies a predetermined condition to be the reference point (x_{c}, y_{c}). For example, the predetermined condition is “the sum of distances to each of the plurality of straight lines is minimum” but is not limited thereto.

For example, the first estimation unit 11 may compute a point satisfying the predetermined condition in accordance with Equations (1) to (3) below.

$$\begin{matrix}Math . 1 & \\ y = {k}_{i} x + {c}_{i} & Equation 1\end{matrix}$$

$$\begin{matrix}Math . 2 & \\ Dist ( x , y , {k}_{i} , {c}_{i} ) = \frac{\vert {k}_{i} x - y + {c}_{i} \vert}{\sqrt{{k}_{i}^{2} + 1}} & Equation 2\end{matrix}$$

$$\begin{matrix}Math . 3 & \\ ( {x}_{c} , {y}_{c} ) = arg {min}_{( x , y )} {\sum }_{i} Dist ( x , y , {k}_{i} , {c}_{i} ) & Equation 3\end{matrix}$$

First, each of the straight lines L1 to L5 is expressed by Equation (1). Note that k, denotes the slope of each straight line, and cᵢ denotes the intercept of each straight line. A point minimizing the sum of the distances to the straight lines L1 to L5 can be computed as the reference point (x_{c}, y_{c}) by Equation (2) and Equation (3).

Note that when the installed position or the orientation of a camera is fixed, reference points (x_{c}, y_{c}) set in a plurality of fisheye images generated by the camera represent the same position. Therefore, when computing a reference point (x_{c}, y_{c}) in one fisheye image in the aforementioned processing, the first estimation unit 11 may register the computed reference point (x_{c}, y_{c}) in association with a camera generating the fisheye image. Then, from there onward, computation of the aforementioned reference point (x_{c}, y_{c}) may not be performed on a fisheye image generated by the camera, and the registered reference point (x_{c}, y_{c}) may be read and used.

### Image Complementation

When the reference point (x_{c}, y_{c}) determined in the aforementioned processing is different from the center of an intra-image-circle image in the fisheye image, the first estimation unit 11 generates a complemented circular image by complementing the intra-image-circle image in the fisheye image with an image. Note that when the reference point (x_{c}, y_{c}) matches the center of the intra-image-circle image in the fisheye image, the first estimation unit 11 does not execute the image complementation.

A complemented circular image is an image acquired by adding a complementing image to an intra-image-circle image and is a circular image the center of which is the reference point (x_{c}, y_{c}). Note that the radius of the complemented circular image may be the maximum value of the distance from the reference point (x_{c}, y_{c}) to a point on the outer periphery of the intra-image-circle image, and the intra-image-circle image may be inscribed in the complemented circular image. The complementing image added to the intra-image-circle image may be a solid-color (for example, black) image, may be any patterned image, or may be some other image.

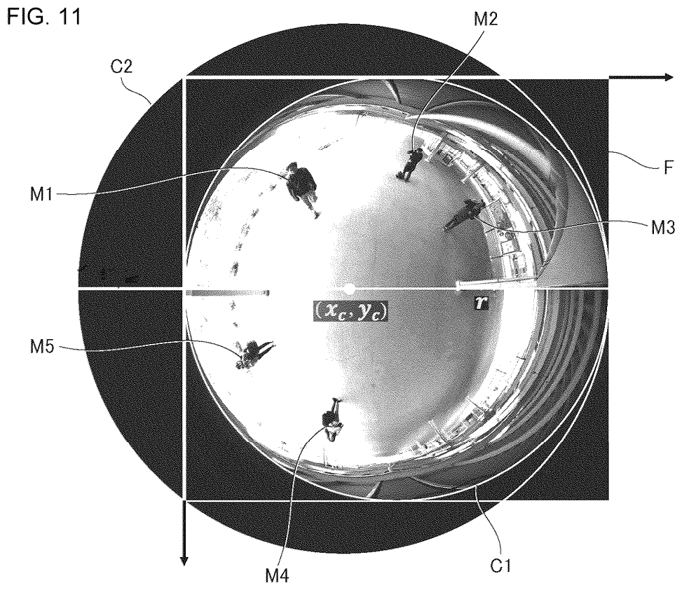

FIG. 11 illustrates an example of a complemented circular image C2 generated by the first estimation unit 11. The complemented circular image C2 is generated by adding a solid black complementing image to the intra-image-circle image C1 in the fisheye image F. As illustrated, the complemented circular image C2 is a circle with the reference point (x_{c}, y_{c}) at the center. Then, the radius r of the complemented circular image C2 is the maximum value of the distance from the reference point (x_{c}, y_{c}) to a point on the outer periphery of the intra-image-circle image C1. Note that the intra-image-circle image C1 is inscribed in the complemented circular image C2.

### Determination of Reference Line Lₛ

The reference line Lₛ is a line connecting the reference point (x_{c}, y_{c}) to any point on the outer periphery of a circular image (such s the intra-image-circle image C1 or the complemented circular image C2). The position of the reference line Lₛ is a position where the circular image is cut open at panoramic expansion. For example, the first estimation unit 11 may set the reference line Lₛ not overlapping a person. Such setting of the reference line Lₛ can suppress inconvenience of a person being separated into two parts in a panoramic image.

There are various techniques for setting a reference line Lₛ not overlapping a person. For example, the first estimation unit 11 may not set a reference line Lₛ within a predetermined distance from a plurality of points of the body of each person that are detected in the aforementioned processing and set a reference line Lₛ at a location apart from the aforementioned plurality of detected points by the predetermined distance or greater.

### Determination of Width w and Height h

The width w is the width of a panoramic image, and the height h is the height of the panoramic image. The values may be default values or may be freely set and be registered in the image processing apparatus 10 by a user.

### Panoramic Expansion

After determining the reference line Lₛ, the reference point (x_{c}, y_{c}), the width w, and the height h, the first estimation unit 11 generates a panoramic image by panoramically expanding the fisheye image. Note that when the reference point (x_{c}, y_{c}) is different from the center of the intra-image-circle image in the fisheye image, the first estimation unit 11 generates a panoramic image by panoramically expanding a complemented circular image. On the other hand, when the reference point (x_{c}, y_{c}) matches the center of the intra-image-circle image in the fisheye image, the first estimation unit 11 generates a panoramic image by panoramically expanding the intra-image-circle image in the fisheye image. The first estimation unit 11 can perform panoramic expansion by using the technique described by using FIG. 1.

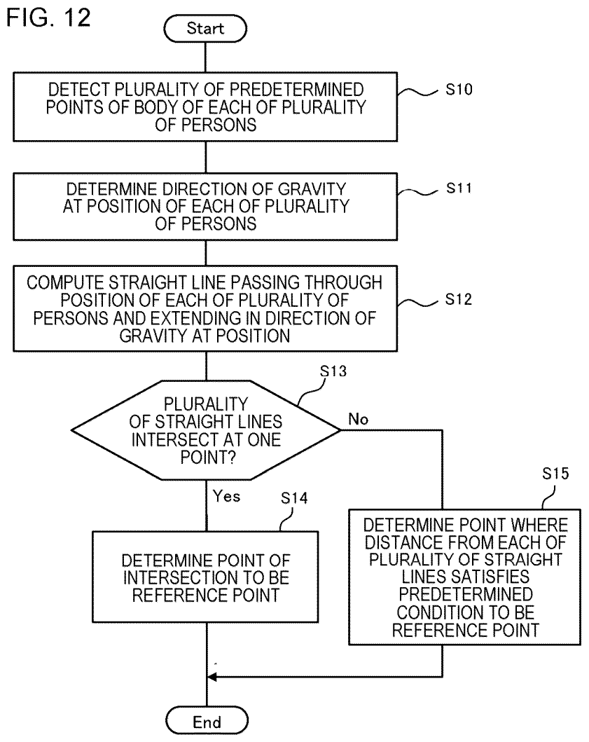

Next, an example of a flow of processing in the panoramic expansion processing will be described. Note that details of each type of processing have been described above, and therefore description thereof is omitted as appropriate. First, by using a flowchart in FIG. 12, an example of a flow of processing of determining a reference point (x_{c}, y_{c}) will be described.

When a fisheye image is input, the first estimation unit 11 detects a plurality of predetermined points of the body of a plurality of persons from an intra-image-circle image (S10). For example, the first estimation unit 11 detects the midpoint P1 between both shoulders and the midpoint P2 between hips for each person.

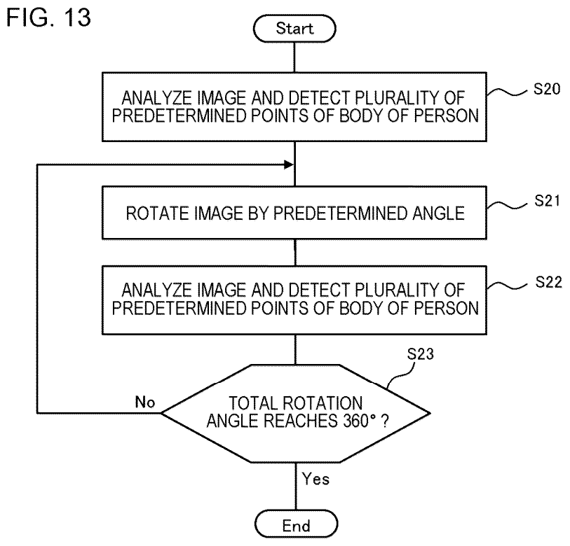

An example of a flow of the processing in S10 will be described by using a flowchart in FIG. 13. First, the first estimation unit 11 analyzes the intra-image-circle image and detects the plurality of predetermined points of the body of each of the plurality of persons (S20). Subsequently, the first estimation unit 11 rotates the intra-image-circle image by a predetermined angle (S21). For example, the predetermined angle is 90° but is not limited thereto.

Then, the first estimation unit 11 analyzes the intra-image-circle image after rotation and detects the plurality of predetermined points of the body of each of the plurality of persons (S22). Then, when the total rotation angle does not reach 360° (No in S23), the first estimation unit 11 returns to S21 and repeats the same processing. On the other hand, when the total rotation angle reaches 360° (Yes in S23), the first estimation unit 11 ends the processing.

Returning to FIG. 12, after S10, the first estimation unit 11 determines a direction of gravity at the position of each of the plurality of persons, based on the plurality of predetermined points detected in S10 (S11). For example, the first estimation unit 11 determines a direction from the midpoint P1 between both shoulders toward the midpoint P2 between hips of each person to be the direction of gravity at the position of the person.

Next, the first estimation unit 11 computes a straight line passing through the position of each of the plurality of persons and extending in the direction of gravity at the position (S12). Then, when a plurality of straight lines intersect at one point (Yes in S13), the first estimation unit 11 determines the point of intersection to be a reference point (x_{c}, y_{c}) (S14). On the other hand, when the plurality of straight lines do not intersect at one point (No in S13), the first estimation unit 11 determines a point where the distance from each of the plurality of straight lines satisfies a predetermined condition (for example, shortest) and determines the point to be a reference point (x_{c}, y_{c}) (S15).

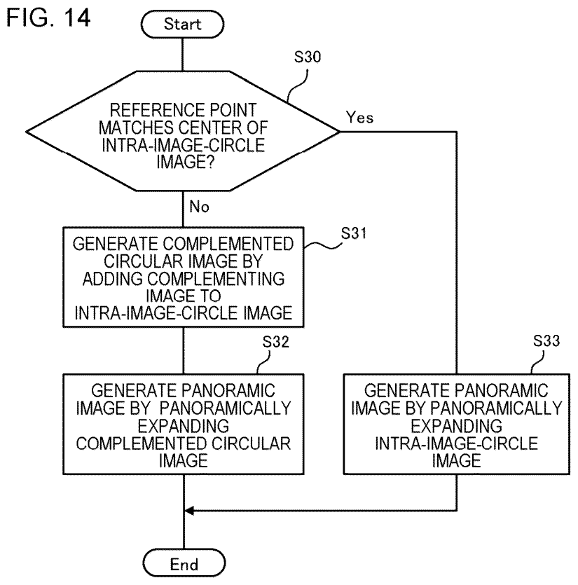

Next, an example of a flow of processing of performing panoramic expansion will be described by using a flowchart in FIG. 14.

When the reference point (x_{c}, y_{c}) determined in the processing in FIG. 12 matches the center of the intra-image-circle image in the fisheye image (Yes in S30), the first estimation unit 11 generates a panoramic image by panoramically expanding the intra-image-circle image in the fisheye image by using the technique described by using FIG. 1 (S33). In other words, generation of a complemented circular image and panoramic expansion of a complemented circular image are not performed in this case.

On the other hand, when the reference point (x_{c}, y_{c}) determined in the processing in FIG. 12 does not match the center of the intra-image-circle image in the fisheye image (No in S30), the first estimation unit 11 generates a complemented circular image (S31). The complemented circular image is a circular image acquired by adding a complementing image to the intra-image-circle image and is an image with the reference point (x_{c}, y_{c}) being the center of the circle. Note that the radius of the complemented circular image may be the maximum value of the distance from the reference point (x_{c}, y_{c}) to a point on the outer periphery of the intra-image-circle image, and the intra-image-circle image may be inscribed in the complemented circular image. The complementing image added to the intra-image-circle image may be a solid-color (for example, black) image, may be any patterned image, or may be some other image.

Then, the first estimation unit 11 generates a panoramic image by panoramically expanding the complemented circular image by using the technique described by using FIG. 1 (S32).

### First Estimation Processing

In the first estimation processing, based on the plurality of generated time-series panoramic images and a first estimation model, the first estimation unit 11 estimates a human action indicated by the plurality of time-series panoramic images.

First, from the plurality of time-series panoramic images, the first estimation unit 11 generates three-dimensional feature information indicating changes in a feature over time at each position in the image. For example, the first estimation unit 11 can generate three-dimensional feature information, based on a 3D CNN (examples of which include a convolutional deep learning network such as a 3D Resnet but are not limited thereto).

Further, the first estimation unit 11 generates human position information indicating a position where a person exists in each of the plurality of time-series panoramic images. When a plurality of persons exist in an image, the first estimation unit 11 can generate human position information indicating a position where each of the plurality of persons exists. For example, the first estimation unit 11 extracts a silhouette (the whole body) of a person in an image and generates human position information indicating an area in the image including the extracted silhouette. The first estimation unit 11 can generate human position information, based on a deep learning technology and more specifically, based on “a deep learning network for object recognition” providing high speed and high precision recognition of every object (such as a person) in a plane image or a video. Examples of the deep learning network for object recognition include a Mask-RCNN, an RCNN, a Fast RCNN, and a Faster RCNN but are not limited thereto. Note that the first estimation unit 11 may perform similar human detection processing on each of the plurality of time-series panoramic images or may track a once detected person by using a human tracking technology in the image and determine the position of the person.

Subsequently, the first estimation unit 11 estimates a human action indicated by the plurality of panoramic images, based on changes in a feature indicated by three-dimensional feature information over time at a position where a person indicated by the human position information exists. For example, after performing a correction of changing the values at positions excluding the position where the person indicated by the human position information exists to a predetermined value (for example, 0) on the three-dimensional feature information, the first estimation unit 11 may estimate a human action indicated by the plurality of images, based on the corrected three-dimensional feature information. The first estimation unit 11 can estimate a human action, based on the first estimation model previously generated by machine learning and the corrected three-dimensional feature information.

The first estimation model may be a model estimating a human action and being generated by machine learning based on an image (learning data) generated by using a standard lens (for example, with an angle of view around 40° to around 60°). In addition, the first estimation model may be a model estimating a human action and being generated by machine learning based on a panoramic image (learning data) generated by panoramically expanding a fisheye image.

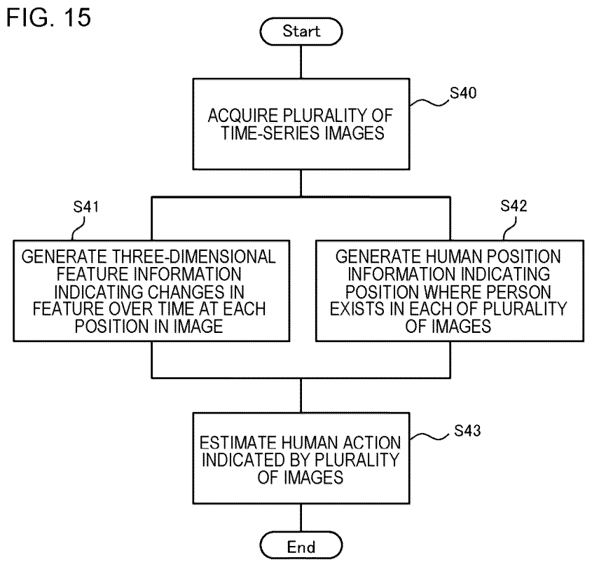

An example of a flow of processing in the first estimation processing will be described by using a flowchart in FIG. 15.

First, the first estimation unit 11 acquires a plurality of time-series panoramic images by executing the aforementioned panoramic expansion processing (S40).

Subsequently, from the plurality of time-series panoramic images, the first estimation unit 11 generates three-dimensional feature information indicating changes in a feature over time at each position in the image (S41). Further, the first estimation unit 11 generates human position information indicating a position where a person exists in each of the plurality of panoramic images (S42).

Then, the first estimation unit 11 estimates a human action indicated by the plurality of images, based on changes in a feature indicated by three-dimensional feature information over time at a position where a person indicated by the human position information exists (S43).

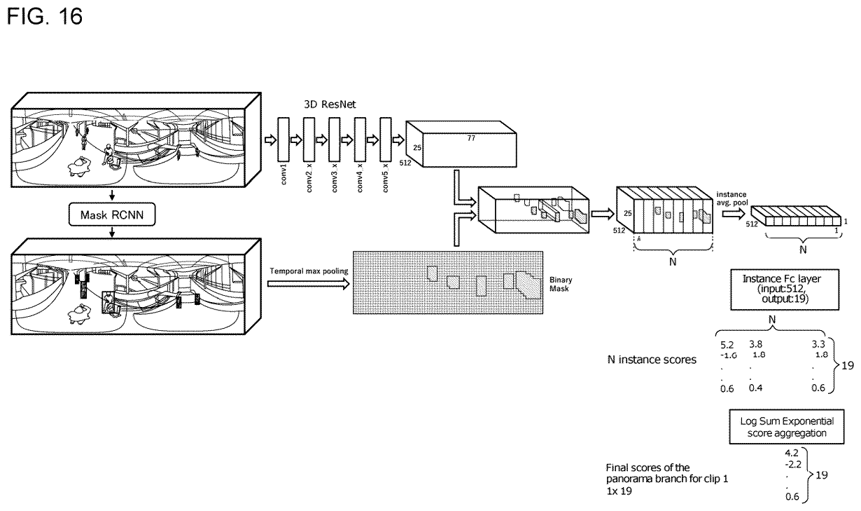

Next, a specific example of the first estimation processing will be described by using FIG. 16. Note that the above is strictly an example, and the processing is not limited thereto.

First, for example, it is assumed that the first estimation unit 11 acquires time-series panoramic images for 16 frames (16×2451×800). Then, the first estimation unit 11 generates three-dimensional feature information convoluted to 512 channels (512×77×25) from the panoramic images for 16 frames, based on a 3D CNN (examples of which include a convolutional deep learning network such as a 3D Resnet but are not limited thereto). Further, the first estimation unit 11 generates human position information (a binary mask in the diagram) indicating a position where a person exists in each of the images for 16 frames, based on a deep learning network for object recognition such as the Mask-RCNN. In the illustrated example, the human position information indicates the position of each of a plurality of rectangular areas including each person.

Next, the first estimation unit 11 performs a correction of changing the values at positions excluding the position where a person indicated by the human position information exists to a predetermined value (for example, 0) on the three-dimensional feature information. Subsequently, the first estimation unit 11 divides the three-dimensional feature information into N blocks (each of which has a width of k) and acquires, for each block, the probability (output value) that each of a plurality of predefined categories (human actions) is included through an average pooling layer, a flatten layer, a fully-connected layer, and the like.

In the illustrated example, 19 categories are defined and learned. The 19 categories include “walking,” “running,” “waving a hand,” “picking up an object,” “discarding an object,” “taking off a jacket,” “putting on a jacket,” “placing a call,” “using a smartphone,” “eating a snack,” “going up the stairs,” “going down the stairs,” “drinking water,” “shaking hands,” “taking an object from another person's pocket,” “handing over an object to another person,” “pushing another person,” “holding up a card and entering a station premise,” and “holding up a card and exiting a ticket gate at a station” but are not limited thereto. For example, the processing apparatus 20 estimates that a human action related to a category the probability of which is a threshold value or greater is indicated in the image.

Note that “N instance scores” in the diagram indicates the probability that each of N blocks included in the plurality of time-series panoramic images includes each of the aforementioned 19 categories. Then, “Final scores of the panorama branch for clip 1” in the diagram indicates the probability that the plurality of time-series panoramic images include each of the aforementioned 19 categories. While details of processing of computing “Final scores of the panorama branch for clip 1” from “N instance scores” is not particularly limited, an example thereof will be described below.

In the arithmetic processing, use of a function returning a statistic of a plurality of values is considered. For example, use of an average function returning an average value [see Equation (4)], a max function returning a maximum value [see Equation (5)], or a log-sum-exp function smoothly approximating the max function [see Equation (6)] is considered. The functions are widely known, and therefore description thereof is omitted.

$$\begin{matrix}Math . 4 & \\ {s}^{a} = \frac{1}{N} {\sum }_{i}^{N} {s}_{i}^{a} & Equation 4\end{matrix}$$

$$\begin{matrix}Math . 5 & \\ {s}^{a} = {max}_{i} {s}_{i}^{a} & Equation 5\end{matrix}$$

$$\begin{matrix}Math . 6 & \\ {s}^{a} = \frac{1}{r} log [ \frac{1}{N} {{\sum }_{i}}^{N} exp ( {rs}_{i}^{a} ) ] & Equation 6\end{matrix}$$

Note that by tracing back the aforementioned flow in the opposite direction, a position in an image where a category (human action) the probability of which is a threshold value or greater is indicated can be computed.

### Fisheye Processing

The fisheye processing is executed by the second estimation unit 12. As illustrated in FIG. 5, when acquiring a plurality of time-series fisheye images (fisheye image acquisition processing), the second estimation unit 12 generates a plurality of time-series partial fisheye images by cropping out a partial area from each image (first cropping processing). Subsequently, the second estimation unit 12 edits the plurality of generated time-series partial fisheye images and generates a plurality of time-series edited partial fisheye images for each person included in the partial fisheye images (editing processing). Subsequently, based on the plurality of time-series edited partial fisheye images and a second estimation model, the second estimation unit 12 estimates a human action indicated by the plurality of time-series edited partial fisheye images (second estimation processing). Thus, the fisheye processing includes the fisheye image acquisition processing, the first cropping processing, the editing processing, and the second estimation processing. Each type of processing is described in detail below.

### Fisheye Image Acquisition Processing

The second estimation unit 12 acquires a plurality of time-series fisheye images in the fisheye image acquisition processing. The fisheye image acquisition processing executed by the second estimation unit 12 is similar to the fisheye image acquisition processing executed by the first estimation unit 11 described in the panorama processing, and therefore description thereof is omitted.

### First Cropping Processing

In the first cropping processing, the second estimation unit 12 generates a plurality of time-series partial fisheye images by cropping out a partial area from each of a plurality of time-series fisheye images. The second estimation unit 12 crops out an image in a circular area having a radius R and being centered on the reference point (x_{c}, y_{c}) described in the panorama processing as a partial fisheye image. The radius R may be a preset fixed value. In addition, the radius R may be a varying value determined based on an analysis result of the fisheye image. As an example of the latter, the second estimation unit 12 may determine the radius R (the size of the partial fisheye image), based on a detection result of persons (the number of detected persons) existing in a preset central area in the fisheye image. The radius R increases as the number of detected persons increases.

### Editing Processing

In the editing processing, the second estimation unit 12 edits a plurality of generated time-series partial fisheye images and generates a plurality of time-series edited partial fisheye images for each person included in the partial fisheye images. Details of the processing are described below.

First, the second estimation unit 12 analyzes a partial fisheye image and detects a person included in the partial fisheye image. The technique of detecting a person by rotating the partial fisheye image and analyzing the partial fisheye image at each rotation position may be employed in the detection of a person, similarly to the processing described in the panorama processing (the processing in FIG. 13). In addition, the second estimation unit 12 may detect a person included in the partial fisheye image, based on a human detection model generated by machine learning with a fisheye image as learning data. Further, the second estimation unit 12 may perform similar human detection processing on each of the plurality of time-series partial fisheye images or may track a once detected person by using a human tracking technology and determine the position of the person in the dynamic image.

After detecting a person, the second estimation unit 12 generates an edited partial fisheye image by executing, for each detected person, rotation processing of rotating a partial fisheye image and second cropping processing of cropping out a partial area with a predetermined size.

In the rotation processing, a partial fisheye image is rotated in such a way that the direction of gravity at the position of each person is the vertical direction on the image. The means for determining the direction of gravity at the position of each person is as described in the panorama processing, but another technique may be used.

In the second cropping processing, an image including each person and having a predetermined size is cropped out from a partial fisheye image after the rotation processing. The shape and the size of a cropped-out image are predefined.

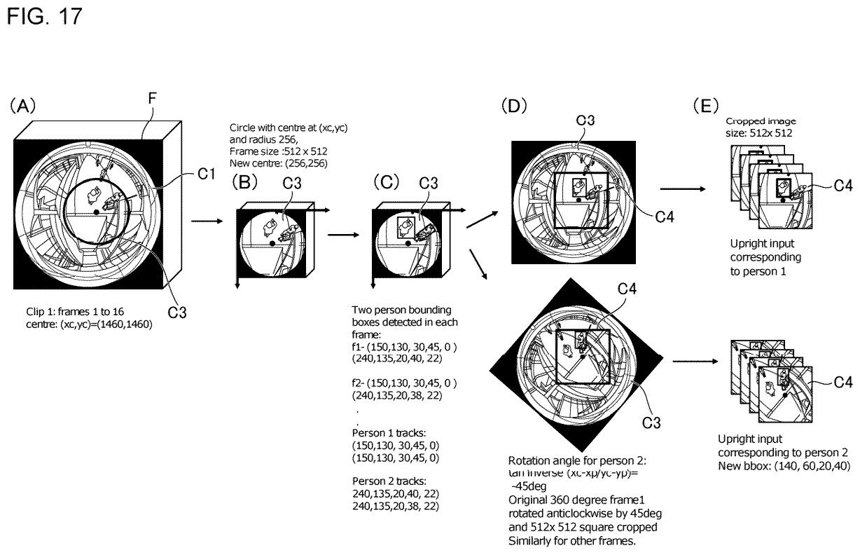

A specific example of the first cropping processing and the editing processing will be described by using FIG. 17.

First, as illustrated in (A)→(B), the second estimation unit 12 crops out a partial area in an intra-image-circle image C1 in a fisheye image F as a partial fisheye image C3 (first cropping processing). The processing is executed for each fisheye image F.

Next, as illustrated in (B)→(C), the second estimation unit 12 detects a person from the partial fisheye image C3. Two persons are detected in the illustrated example.

Next, as illustrated in (C)→(D), the second estimation unit 12 executes the rotation processing on the partial fisheye image C3 for each detected person. As illustrated, in the partial fisheye image C3 after rotation, the direction of gravity at the position of each person is the vertical direction on the image. The processing is executed for each partial fisheye image C3.

Next, as illustrated in (D)→(E), the second estimation unit 12 generates an edited partial fisheye image C4 for each detected person by cropping out an image including the person and having a predetermined size from the partial fisheye image C3 after rotation. The processing is executed for each detected person and for each partial fisheye image C3.

### Second Estimation Processing

In the second estimation processing, based on the plurality of generated time-series edited partial fisheye images and the second estimation model, the second estimation unit 12 estimates a human action indicated by the plurality of time-series edited partial fisheye images. The estimation processing of a human action by the second estimation unit 12 is basically similar to the estimation processing of a human action by the first estimation unit 11.

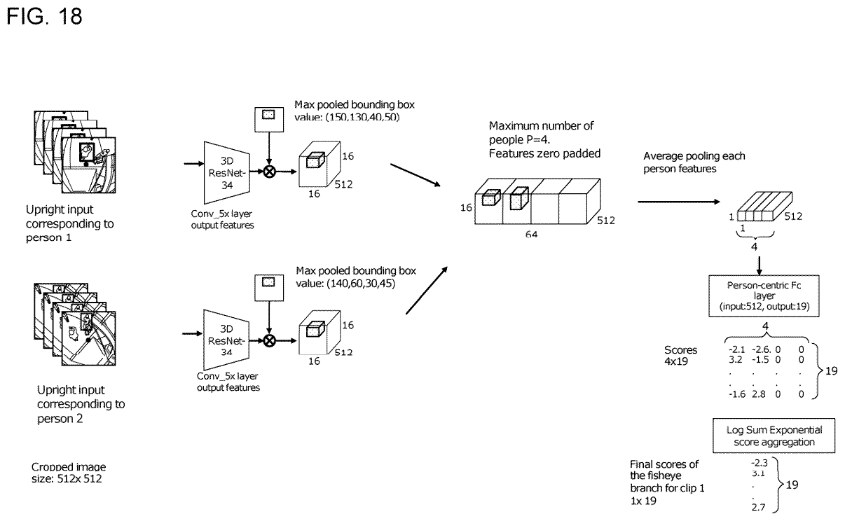

As illustrated in FIG. 18, the second estimation unit 12 generates three-dimensional feature information indicating changes in a feature over time at each position in an image from a plurality of time-series edited partial fisheye images related to a first person. For example, the second estimation unit 12 can generate three-dimensional feature information, based on a 3D CNN (examples of which include a convolutional deep learning network such as the 3D Resnet but are not limited thereto). Subsequently, the second estimation unit 12 performs processing of highlighting the value of a position where the person is detected on the generated three-dimensional feature information.

The second estimation unit 12 performs the processing for each person detected from a partial fisheye image. Then, after concatenating “three-dimensional feature information in which the value of a position where a person is detected is highlighted” computed for each person, the probability (output value) that each of a plurality of predefined categories (human actions) is included in a plurality of time-series edited partial fisheye images related to each person is acquired through similar types of processing such as the average pooling layer, the flatten layer, and the fully-connected layer.

Subsequently, the second estimation unit 12 performs an arithmetic operation of computing the probability that each of the plurality of categories (human actions) is included in the partial fisheye image by aggregating the probabilities that each of the plurality of categories (human actions) is included in the plurality of time-series edited partial fisheye images related to the respective persons.

In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

As is apparent from the description up to this point, the second estimation unit 12 performs image analysis on a partial fisheye image being a partial area in a fisheye image without panoramic expansion and estimates a human action indicated by the partial fisheye image.

### Aggregation Processing

The aggregation processing is executed by the third estimation unit 13. As illustrated in FIG. 5, the third estimation unit 13 estimates a human action indicated by a fisheye image, based on an estimation result based on a panoramic image acquired in the panorama processing and an estimation result based on a partial fisheye image acquired in the fisheye processing.

As described above, each of an estimation result based on a panoramic image and an estimation result based on a partial fisheye image indicates the probability of including each of a plurality of predefined human actions. The third estimation unit 13 computes the probability that a fisheye image includes each of the plurality of predefined human actions by predetermined arithmetic processing based on an estimation result based on a panoramic image and an estimation result based on a partial fisheye image.

In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

### Example

Next, an example of the image processing apparatus 10 will be described. Note that the example to be described is an example when the image processing apparatus 10 according to the present example embodiment is implemented but is not limited thereto.

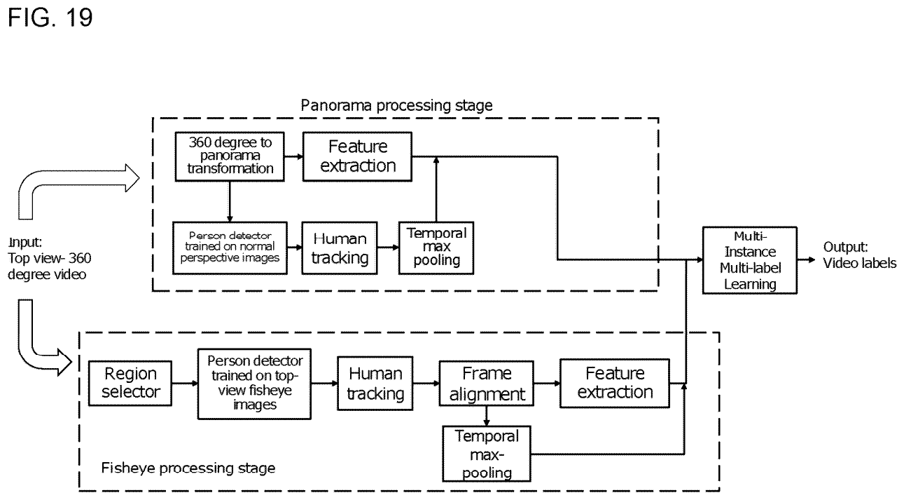

FIG. 19 is an example of a block diagram of the image processing apparatus 10 in this example. As described above, a basic configuration of the image processing apparatus 10 includes the panorama processing, the fisheye processing, and the aggregation processing. A basic structure of each type of processing is also as described above.

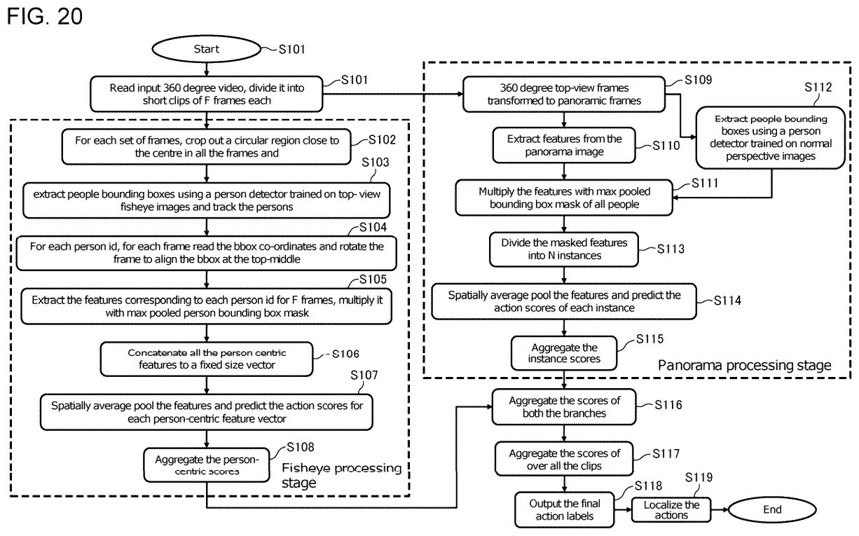

FIG. 20 is a flowchart illustrating a flow of processing in the image processing apparatus in this example.

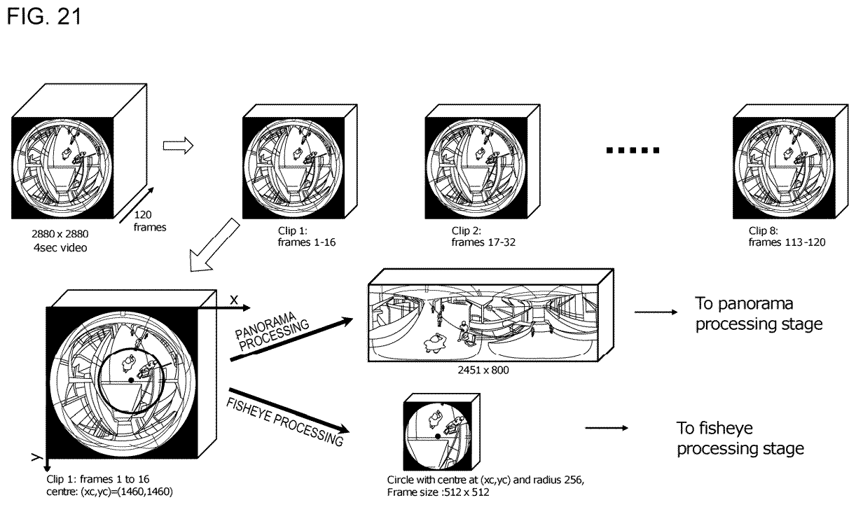

In S101, the image processing apparatus 10 divides a plurality of input time-series fisheye images into a plurality of clips each including a predetermined number of images. FIG. 21 illustrates a specific example. In the illustrated example, 120 time-series fisheye images are input, and the images are divided into eight clips. Each clip includes 16 fisheye images while only the last clip includes eight fisheye images. Subsequently, the fisheye processing (S102 to S108), the panorama processing (S109 to S115), and the aggregation processing (S116) are executed for each clip.

Details of the fisheye processing (S102 to S108) are illustrated in FIG. 17 and FIG. 18. In the fisheye processing, the image processing apparatus 10 generates a plurality of time-series partial fisheye images C3 by extracting a partial area in each of a plurality of time-series fisheye images F [S102: (A)→(B) in FIG. 17]. Subsequently, the image processing apparatus 10 detects a person from the plurality of time-series partial fisheye images C3 and tracks the person in the dynamic image [S103: (B)→(C) in FIG. 17].

Next, the image processing apparatus 10 executes, for each detected person, the rotation processing [(C)→(D) in FIG. 17] on the partial fisheye image C3 and processing of cropping out an image including each person and having a predetermined size from the partial fisheye image C3 after rotation [(D)→(E) in FIG. 17] (S104). Thus, a plurality of time-series edited partial fisheye images C4 are acquired for each detected person.

In subsequent S105, for each detected person, the image processing apparatus 10 generates three-dimensional feature information by inputting each of the plurality of time-series edited partial fisheye images to a 3D CNN (examples of which include a convolutional deep learning network such as the 3D Resnet but are not limited thereto), as illustrated in FIG. 18. Further, the image processing apparatus 10 performs processing of highlighting the value of a position where a person is detected on the generated three-dimensional feature information.

Next, the image processing apparatus 10 concatenates the pieces of three-dimensional feature information acquired for the respective persons (S106). Subsequently, the image processing apparatus 10 acquires the probability (output value) that each of a plurality of predefined categories (human actions) is included in a plurality of time-series edited partial fisheye images related to each person through the average pooling layer, the flatten layer, the fully-connected layer, and the like (S107).

Subsequently, the image processing apparatus 10 performs an arithmetic operation of computing the probability that each of the plurality of categories (human actions) is included in the plurality of time-series partial fisheye images by aggregating the probabilities that each of the plurality of categories (human actions) is included in the plurality of time-series edited partial fisheye images related to the respective persons (S108). In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

Details of the panorama processing (S109 to S115) are illustrated in FIG. 16. In the panorama processing, after panoramically expanding a plurality of time-series fisheye images (S109), the image processing apparatus 10 generates three-dimensional feature information convoluted to 512 channels (512×77×25) from the plurality of time-series panoramic images, based on a 3D CNN (examples of which include a convolutional deep learning network such as the 3D Resnet but are not limited thereto) (S110). Further, the image processing apparatus 10 generates human position information indicating the position where a person exists in each of the plurality of time-series panoramic images, based on a deep learning network for object recognition such as the Mask-RCNN (S112).

Next, the image processing apparatus 10 performs a correction of changing the values at positions excluding the position where a person indicated by the human position information generated in S112 exists to a predetermined value (for example, 0) on the three-dimensional feature information generated in S110 (S111).

Subsequently, the image processing apparatus 10 divides the three-dimensional feature information into N blocks (each of which has a width of k) (S113) and acquires the probability (output value) that each of the plurality of predefined categories (human actions) is included for each block through the average pooling layer, the flatten layer, the fully-connected layer, and the like (S114).

Subsequently, the image processing apparatus 10 performs an arithmetic operation of computing the probability that each of the plurality of categories (human actions) is included in the plurality of time-series panoramic images by aggregating the probabilities that each of the plurality of categories (human actions) is included, the probabilities being acquired for the respective blocks (S115). In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

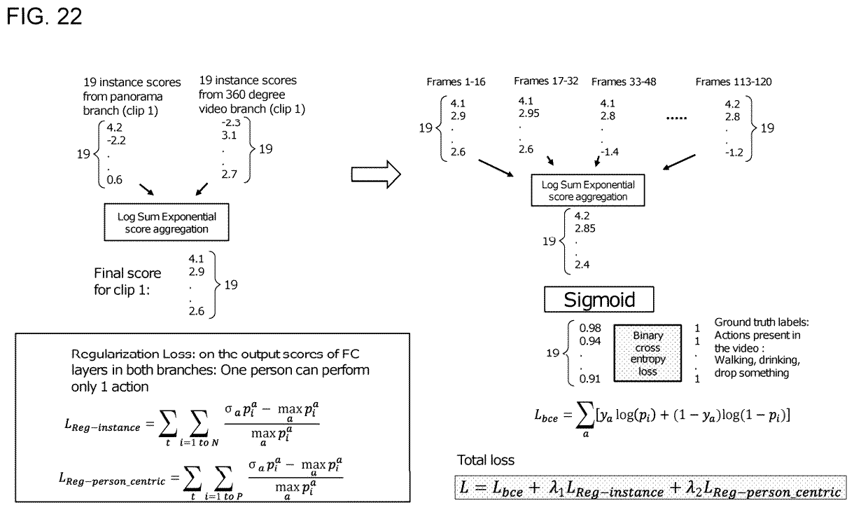

Subsequently, the image processing apparatus 10 performs an arithmetic operation of computing the probability that each of the plurality of categories (human actions) is included in a plurality of time-series fisheye images included in each clip by aggregating “the probability that each of the plurality of categories (human actions) is included in the plurality of time-series partial fisheye images” acquired in the fisheye processing and “the probability that each of the plurality of categories (human actions) is included in the plurality of time-series panoramic images” acquired in the panorama processing (S116, see FIG. 22). In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

By performing the processing up to this point for each clip, “the probability that each of the plurality of categories (human actions) is included in a plurality of time-series fisheye images included in the clip” is acquired for the clip. In S117, an arithmetic operation of computing “the probability that each of the plurality of categories (human actions) is included in the input 120 time-series fisheye images” by aggregating a plurality of “the probabilities that each of the plurality of categories (human actions) is included in a plurality of time-series fisheye images included in the respective clips” acquired for the respective clips is performed (see FIG. 22). In the arithmetic processing, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

Subsequently, the image processing apparatus 10 performs output of the computation result (S118) and position determination of the human action predicted to be included (S119).

Note that in a learning stage, the image processing apparatus 10 transforms “the probability that each of the plurality of categories (human actions) is included in the input 120 time-series fisheye images” into a value between 0 and 1 by applying a sigmoid function, as illustrated in FIG. 22. Then, the image processing apparatus 10 performs learning in such a way as to optimize the value of an illustrated total loss1 function.

### MODIFIED EXAMPLES

### First Modified Example

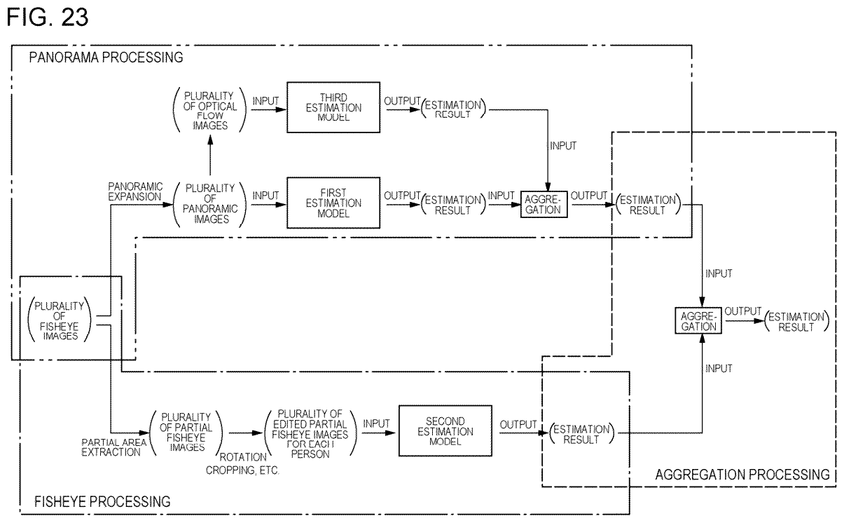

FIG. 23 illustrates a flow of a modified example. As is apparent from comparison with FIG. 5, a structure of the panorama processing in the modified example is different from that according to the aforementioned example embodiment. The panorama processing in the modified example will be described in detail below.

First, the first estimation unit 11 computes a first estimation result of a human action indicated by a plurality of time-series panoramic images by performing image analysis. The processing is the same as the processing in the panorama processing described in the aforementioned example embodiment.

Further, the first estimation unit 11 computes a second estimation result of a human action indicated by a panoramic image by performing image analysis on an optical flow image generated from the panoramic image. An optical flow image is acquired by imaging a vector representing movement of an object in a plurality of time-series panoramic images. Computation of the second estimation result is provided by replacing “a plurality of time-series panoramic images” with “a plurality of time-series optical flow images” in “the processing of estimating a human action indicated by a plurality of time-series panoramic images” described in the aforementioned example embodiment.

Then, the first estimation unit 11 estimates a human action indicated by the plurality of time-series panoramic images, based on the first estimation result and the second estimation result. The estimation result is aggregated with an estimation result acquired in the fisheye processing.

In aggregation of the first estimation result and the second estimation result, use of a function returning a statistic of a plurality of values is considered. For example, use of the average function returning an average value [see aforementioned Equation (4)], the max function returning a maximum value [see aforementioned Equation (5)], or the log-sum-exp function smoothly approximating the max function [see aforementioned Equation (6)] is considered.

### Second Modified Example

While the image processing apparatus 10 performs generation of a panoramic image, generation of a partial fisheye image, and generation of an edited partial fisheye image, according to the aforementioned example embodiment, another apparatus different from the image processing apparatus 10 may perform at least one type of the processing. Then, an image (at least one of a panoramic image, a partial fisheye image, and an edited partial fisheye image) generated by the other apparatus may be input to the image processing apparatus 10. In this case, the image processing apparatus 10 performs the aforementioned processing by using the input image.

### Third Modified Example

In the panorama processing, processing of eliminating information of a part (hereinafter “that part”) related to a partial area extracted in the fisheye processing (for example, applying a solid-color or a predetermined pattern to that part) may be executed on a generated panoramic image. Then, a human action may be estimated based on the panoramic image after the processing and the first estimation model. Since a human action included in that part is estimated in the fisheye processing, the information of that part can be eliminated from the panoramic image. However, when a person positioned in both that part and another part exists, a situation such as degraded estimation precision of a human action or the like may occur. Therefore, the processing is preferably executed without eliminating the information of that part from the panoramic image, as is the case in the aforementioned example embodiment.

### Fourth Modified Example

In the editing processing according to the example embodiment described above, the second estimation unit 12 detects a person included in a partial fisheye image by analyzing the partial fisheye image. As a modified example of the “processing of detecting a person included in a partial fisheye image,” the second estimation unit 12 may perform the following processing. First, the second estimation unit 12 detects a person included in a fisheye image by analyzing the fisheye image. Subsequently, the second estimation unit 12 detects a person the detection position (coordinates) of whom in the fisheye image satisfies a predetermined condition (in an area cropped out as a partial fisheye image) from among persons detected from the fisheye image. The processing of detecting a person from a fisheye image is provided by an algorithm similar to an algorithm for the aforementioned processing of detecting a person from a partial fisheye image. The modified example improves detection precision of a person included in a partial fisheye image.

### Advantageous Effect

As a first comparative example of the present example embodiment, processing of estimating a human action of a person included in a fisheye image by executing only the panorama processing without executing the fisheye processing and the aggregation processing is considered.

However, as described above, an image around a reference point (x_{c}, y_{c}) is considerably enlarged when a panoramic image is generated from a fisheye image, and therefore a person around the reference point (x_{c}, y_{c}) may be considerably distorted in the panoramic image. Therefore, issues such as failed detection of the distorted person and degraded estimation precision may occur in the first comparative example.

Further, as a second comparative example of the present example embodiment, processing of estimating a human action of a person included in a fisheye image by processing the entire fisheye image without panoramic expansion similarly to the aforementioned fisheye processing without executing the panorama processing and the aggregation processing is considered.

However, when many persons are included in a fisheye image, the number of images to be generated and processed becomes enormous, and a processing load of the computer increases. When processing similar to the aforementioned fisheye processing is to be performed, a human action for each of the plurality of persons is estimated by detecting persons included in the fisheye image, generating a plurality of images (corresponding to edited partial fisheye images) by adjusting, for each person, the orientation of the person in the image, and processing the images. Naturally, as the number of detected persons increases, the number of images to be generated and processed becomes enormous.

The image processing apparatus 10 according to the present example embodiment can solve these issues. The image processing apparatus 10 according to the present example embodiment estimates a human action of a person included in a fisheye image by aggregating a human action estimated by analyzing a panoramic image and a human action estimated by analyzing a partial image around a reference point (x_{c}, y_{c}) in the fisheye image without panoramic expansion.

When the partial image around the reference point (x_{c}, y_{c}) in the fisheye image is analyzed without panoramic expansion, an issue of a person around the aforementioned reference point (x_{c}, y_{c}) being considerably distorted does not occur. Therefore, a person around the reference point (x_{c}, y_{c}) can be detected and a human action of the person can be estimated with high precision. In other words, the issue of the aforementioned first comparative example can be solved.

Further, only “a partial image around a reference point (x_{c}, y_{c}) in a fisheye image” that may cause an issue in a panoramic image is analyzed without panoramic expansion, and the remaining part is excluded from the target of the processing. Therefore, the number of persons detected in the fisheye processing is controlled. As a result, compared with the aforementioned second comparative example, the number of images (edited partial fisheye images) to be generated and processed in the fisheye processing can be controlled, and a processing load of the computer can be reduced.

While the present invention has been described above with reference to the example embodiments (and the examples) thereof, the present invention is not limited to the aforementioned example embodiments (and examples). Various changes and modifications that may be understood by a person skilled in the art may be made to the configurations and details of the present invention without departing from the scope of the present invention.

Part or the whole of the example embodiments disclosed above may also be described as, but not limited to, the following supplementary notes.

1. An image processing apparatus including:

a first estimation unit that performs image analysis on a panoramic image acquired by panoramically expanding a fisheye image generated by a fisheye lens camera and estimating a human action indicated by the panoramic image;

a second estimation unit that performs image analysis on a partial fisheye image being a partial area in the fisheye image without panoramic expansion and estimating a human action indicated by the partial fisheye image; and

a third estimation unit that estimates a human action indicated by the fisheye image, based on an estimation result based on the panoramic image and an estimation result based on the partial fisheye image.

2. The image processing apparatus according to 1, wherein

the second estimation unit determines an image in a circular area to be the partial fisheye image, the circular area being centered on a reference point in the fisheye image, the reference point being determined based on a direction of gravity at a position of each of a plurality of persons existing in the fisheye image.

3. The image processing apparatus according to 2, wherein

a direction of gravity at a position of each of a plurality of persons existing in the fisheye image is determined based on a plurality of predetermined points of a body that are detected from each of the plurality of persons.

4. The image processing apparatus according to any one of 1 to 3, wherein

the second estimation unit determines a size of the partial fisheye image, based on a detection result of a person existing in the fisheye image.

5. The image processing apparatus according to any one of 1 to 4, wherein

the second estimation unit
generates an edited partial fisheye image for each person detected in the partial fisheye image by executing processing of rotating the partial fisheye image and processing of cropping out a partial area with a predetermined size and
estimates a human action indicated by the partial fisheye image by analyzing the edited partial fisheye image.
   6. The image processing apparatus according to any one of 1 to 5, wherein

each of an estimation result based on the panoramic image and an estimation result based on the partial fisheye image indicates a probability that each of a plurality of predefined human actions is included, and

the third estimation unit computes a probability that the fisheye image includes each of the plurality of predefined human actions by a predetermined arithmetic processing based on an estimation result based on the panoramic image and an estimation result based on the partial fisheye image.

7. The image processing apparatus according to any one of 1 to 6, wherein

the first estimation unit
computes a first estimation result of a human action indicated by the panoramic image by performing image analysis on the panoramic image,
computes a second estimation result of a human action indicated by the panoramic image by performing image analysis on an optical flow image generated from the panoramic image, and
estimates a human action indicated by the panoramic image, based on the first estimation result and the second estimation result.
   8. An image processing method including, by a computer:

performing image analysis on a panoramic image acquired by panoramically expanding a fisheye image generated by a fisheye lens camera and estimating a human action indicated by the panoramic image;

performing image analysis on a partial fisheye image being a partial area in the fisheye image without panoramic expansion and estimating a human action indicated by the partial fisheye image; and

estimating a human action indicated by the fisheye image, based on an estimation result based on the panoramic image and an estimation result based on the partial fisheye image.

9. A program causing a computer to function as:

a first estimation unit that performs image analysis on a panoramic image acquired by panoramically expanding a fisheye image generated by a fisheye lens camera and estimating a human action indicated by the panoramic image;

a second estimation unit that performs image analysis on a partial fisheye image being a partial area in the fisheye image without panoramic expansion and estimating a human action indicated by the partial fisheye image; and

a third estimation unit that estimates a human action indicated by the fisheye image, based on an estimation result based on the panoramic image and an estimation result based on the partial fisheye image.

What is claimed is:

1. An image processing apparatus comprising:
at least one memory configured to store one or more instructions; and
at least one processor configured to execute the one or more instructions to:
estimate, based on a panoramic image acquired by panoramically expanding a fisheye image generated by a fisheye lens camera, a human action indicated by the panoramic image;
estimate, based on a partial fisheye image being a partial area in the fisheye image without panoramic expansion, a human action indicated by the partial fisheye image; and
estimate a human action indicated by the fisheye image, based on an estimation result based on the panoramic image and an estimation result based on the partial fisheye image.

2. The image processing apparatus according to claim 1, wherein
the estimating a human action indicated by the partial fisheye image includes estimating an image in a circular area to be the partial fisheye image, the circular area being centered on a reference point in the fisheye image, the reference point being determined based on a direction of gravity at a position of each of a plurality of persons existing in the fisheye image.

3. The image processing apparatus according to claim 2, wherein
a direction of gravity at a position of each of a plurality of persons existing in the fisheye image is determined based on a plurality of predetermined points of a body that are detected from each of the plurality of persons.

4. The image processing apparatus according to claim 1, wherein
the estimating a human action indicated by the partial fisheye image includes determining a size of the partial fisheye image, based on a detection result of a person existing in the fisheye image.

5. The image processing apparatus according to claim 1, wherein
the estimating a human action indicated by the partial fisheye image includes:
generating an edited partial fisheye image for each person detected in the partial fisheye image by executing processing of rotating the partial fisheye image and processing of cropping out a partial area with a predetermined size and
estimating a human action indicated by the partial fisheye image by analyzing the edited partial fisheye image.

6. The image processing apparatus according to claim 1, wherein
each of an estimation result based on the panoramic image and an estimation result based on the partial fisheye image indicates a probability that each of a plurality of predefined human actions is included, and
wherein the estimating a human action indicated by the partial fisheye image includes computing a probability that the fisheye image includes each of the plurality of predefined human actions by a predetermined arithmetic processing based on an estimation result based on the panoramic image and an estimation result based on the partial fisheye image.

7. The image processing apparatus according to claim 1, wherein
the estimating a human action indicated by the partial fisheye image includes:
computing a first estimation result of a human action indicated by the panoramic image by performing image analysis on the panoramic image,
computing a second estimation result of a human action indicated by the panoramic image by performing image analysis on an optical flow image generated from the panoramic image, and
estimating a human action indicated by the panoramic image, based on the first estimation result and the second estimation result.

8. An image processing method comprising, by a computer:
estimating, based on a panoramic image acquired by panoramically expanding a fisheye image generated by a fisheye lens camera, a human action indicated by the panoramic image;
estimating, based on a partial fisheye image being a partial area in the fisheye image without panoramic expansion, a human action indicated by the partial fisheye image; and
estimating a human action indicated by the fisheye image, based on an estimation result based on the panoramic image and an estimation result based on the partial fisheye image.

9. A non-transitory storage medium storing a program causing a computer to:
estimate, based on a panoramic image acquired by panoramically expanding a fisheye image generated by a fisheye lens camera, a human action indicated by the panoramic image;
estimate, based on a partial fisheye image being a partial area in the fisheye image without panoramic expansion, a human action indicated by the partial fisheye image; and
estimate a human action indicated by the fisheye image, based on an estimation result based on the panoramic image and an estimation result based on the partial fisheye image.
